(19) United States
(12) Patent Application Publication
(10) Pub. No.: US 2014/0108103 A1
(43) Pub. Date: Apr. 17, 2014

(54) SYSTEMS AND METHODS TO CONTROL WORK PROGRESS FOR CONTENT TRANSFORMATION BASED ON NATURAL LANGUAGE PROCESSING AND/OR MACHINE LEARNING

(71) Applicant: Gengo, Inc., San Mateo, CA (US)

(72) Inventors: Matthew M.I. Romaine, Tokyo (JP); Matthew James Skyrm, Tokyo (JP)

(73) Assignee: Gengo, Inc., San Mateo, CA (US)

(21) Appl. No.: 14/054,292

(22) Filed: Oct. 15, 2013

Related U.S. Application Data
(60) Provisional application No. 61/715,207, filed on Oct. 17, 2012.

(51) Int. Cl. G06Q 10/06

(52) U.S. Cl. CPC G06Q 10/06395
USPC 705/7.41

(57) ABSTRACT

Systems and methods are provided to compute indicators of completeness of the work output of a transformation of text-based content, worker capacity in performing the transformation, and/or the degree of matching between a unit of work and a worker, based on information collected about complexity of works, times and throughput of workers, rating of work outputs and using natural language processing techniques and machine learning techniques, such as language detection, longest common substring, length ratio, document similarity, etc. The indicators are utilized to optimize job pickup and output submission for online crowdsourcing tasks related to transformation of text-based content, such as transcription, translation, proofreading, etc.

### RELATED APPLICATIONS

The present application claims priority to Prov. U.S. Pat. App. Ser. No. 61/715,207, filed Oct. 17, 2012 and entitled “Systems and Methods to Control Work Progress for Content Transformation based on National Language Processing and/or Machine Learning,” the disclosure of which is hereby incorporated herein by reference.

### FIELD OF THE TECHNOLOGY

At least some embodiments of the present disclosure relate to systems and methods configured to accept out-sourced jobs from customers, present the jobs to workers, accept completed job output, and allow job output retrieval by customers.

### BACKGROUND

The Internet provides a communication channel to reach people globally and thus provides access to a pool of diverse workers for labor and expertise. A job outsourcing paradigm termed “crowd-sourcing” typically includes three major parties: customer as the job originator, worker who performs the job submitted by the customer, and rendezvous point for the customer and the worker.

Implementations of crowd-sourcing to utilize the worker pool connected via Internet have the many issues.

For example, the worker pool accessed via Internet includes workers of different skill sets and different skill levels. As a result, the job output quality varies and is generally unpredictable.

For example, even with a pool of highly-skilled workers, mistakes may appear in jobs and degenerate job output quality.

For example, due to subjectivity in determining worker skill levels, it is typically difficult to match job requirements with worker skill sets.

For example, it is difficult to objectively evaluate the jobs performed by a worker to rate the worker accurately.

For example, unscrupulous workers may try to game the system (e.g., by claiming to possess a skill set that they do not possess and performing poorly the job that is assigned accordingly).

### SUMMARY OF THE DESCRIPTION

In one embodiment, systems and methods are configured to quantify job output expectations with respect to quality, turnaround time, and transaction cost, and uses a just-in-time and best-in-time (JIT-BIT) worker selection process and an iterative two-phase work/evaluation process to ensure that the expectations are met.

In one embodiment, systems and methods are provided to compute indicators of completeness of the work output of a transformation of text-based content, worker capacity in performing the transformation, and/or the degree of matching between a unit of work and a worker, based on information collected about complexity of works, times and throughput of workers, rating of work outputs and using natural language processing techniques and machine learning techniques, such as language detection, longest common substring, length ratio, document similarity, etc. The indicators are utilized to optimize job pickup and output submission for online crowdsourcing tasks related to transformation of text-based content, such as transcription, translation, proofreading, etc.

The disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description, which follows.

### BRIEF DESCRIPTION OF THE DRAWINGS

The embodiments are illustrated by way of example and not limitation in the figures of the accompanying drawings in which like references indicate similar elements.

FIG. 1 illustrates a system configured to manage workers according to one embodiment.

FIG. 2 illustrates a system to control quality for translation jobs according to one embodiment.

FIG. 3 illustrates a system to control expectation for outsource jobs according to one embodiment.

FIG. 4 illustrates a system configured to provide services according to one embodiment.

FIG. 5 illustrates a data processing system according to one embodiment.

FIG. 6 illustrates a system configured to control work progress of text-based content transformation according to one embodiment.

FIG. 7 shows a method to control work progress according to one embodiment.

### DETAILED DESCRIPTION

The following description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

In one embodiment, a system and method is configured to provide translation services. In the example of providing the translation services, workers perform works or jobs as translators. Although some embodiments discussed below are illustrated using the example of translation services, the systems and methods disclosed herein can be used to provide other services, such as answering questions, providing advices, etc. Thus, the disclosure is not limited to translation services.

The present disclosure includes a job managing system that is agnostic to job type, rendezvous system, and worker type. For example, a job may be a request for writing software that meets a specification, or a request for translation of a piece of text, etc. For example, a rendezvous system may accept job request, disseminate job requests, and accept job outputs (completed jobs) using a web service or a mixture of virtual and real-world components, such as a physical bulletin board for job postings with an email/physical address at which job outs (completed jobs) can be sent for inspection.

In one embodiment, in response to a job request from a customer the job managing system is configured to present to the customer with one or more multiple-choice questions (e.g., how the job output will be used). Based on the answer(s) selected by the customer, the job managing system is configured to assign predetermined Expectation Metrics (EM) to the job. The job managing system then prompts the customer to accept the Expectation Metrics (EM) assigned to the job. If the customer does not agree with the Expectation Metrics (EM) assigned by the job managing system to the job according to the answer(s) selected by the customer, the customer is prompted to modify his choice(s) for the one or more multiple-choice questions.

After the customer accepts the Expectation Metrics (EM) selected according to the answers provided by the customer to the one or more multiple-choice questions, the job managing system is uses a JIT-BIT scheme to determine to whom and in which order to present (show) the job in the work phase, taking into consideration job properties, worker properties, current Expectation Index (EI), turnaround time, cost, etc. A qualified and available worker interested in performing the job can pick it up from the job managing system and start working on it.

Once a worker has completed the job, the processing of the job enters the evaluation phase. The remaining turnaround time and transaction cost are automatically calculated, while the Expectation Index (EI) of the job is either evaluated automatically by the job managing system, or manually by workers. To evaluate the Expectation Index (EI) of the job, the JIT-BIT scheme is again used to determine to whom and in which order to present the job for evaluation.

When a worker evaluates the Expectation Index (EI) of the job, a User Interface (UI) configured to guide the worker in evaluating the Expectation Index (EI) of the job is provided.

In the evaluation phase, if the Expectation Index (EI) requirement is determined to have been met, or the limit on turnaround time or transaction cost is reached, the job meets the terminal condition for exiting the iterative work-evaluation process; otherwise, the job re-enters into the work phase again to allow workers to further work on it. The job iterates between the work phase and the evaluation phase, until the terminal condition is met.

In one embodiment, after a worker evaluates a job and the job re-enters the work phase, the worker who performed the evaluation is assigned to work on the job during the new work phase to rectify the job.

In one embodiment, after the job managing system evaluates a job in an automated way and the job re-enters the work phase, the JIT-BIT scheme is used to determine to whom and in which order to present the job for further working on the job to the Expectation Index (EI) of the job.

In one embodiment, if a job exits the iterative work-evaluation process due to the limit on turnaround time, or the limit on transaction cost, the customer may be provided with the option to request for a full refund without receiving the job output, or partial payment for the below-par job output.

At each stage of the job, customers, workers, and system operators can opt to view through a user interface (UI), or a query through Application Programming Interface (API), or to receive push notifications about job status and alerts if they have sufficient privileges associated with their roles.

One embodiment of a job submission system includes an electronic database configured to store submitted jobs, which may be submitted via an electronic system having web/application servers configured to accept jobs over Internet protocols, a brick-and-mortar system configured to accept jobs over snail mail.

One embodiment of the disclosure includes methods for describing customer job output expectations, where job output expectations (Expectation Metrics, or EM) include quantifiable requirements on quality, turnaround time, and transaction cost.

In one embodiment, quality requirements (e.g., quality metrics) are pre-defined for different job types. Each type of jobs has a set of pre-defined quality metrics. After the type of a job is identified by a customer (e.g., via a multiple-choice question), the quality requirements associated with the job type is used for the job submitted by the customer.

Quality metrics are configured to be quantifiable automatically or be objectively evaluated by workers using a computer assisted user interface.

One embodiment of the disclosure includes methods for assigning output Expectation Metrics (EM) to jobs. For example, an answer to a single multiple-choice question regarding the intended use of the job output is collected from the customer and used to assign EM to the job submitted by the customer. In one embodiment, each selectable answer for the multiple-choice question is associated with a pre-determined set of Expectation Metrics (EM); and the pre-determined set of Expectation Metrics (EM) associated with each selectable answer can be assigned by a domain expert of the job type, who has access to all data on previous similar jobs, in order to derive the pre-determined Expectation Metrics (EM).

One embodiment of the disclosure includes methods for calculating Expectation Index (EI) of a job. For example, Expectation Index (EI) of a job can be is calculated as the ratio of quality metrics that has been met by the job in current state, in relation with the quality metrics specified in the Expectation Matrix (EM) assigned to the job.

In one embodiment, Expectation Index (EI) calculation is performed in a fully automated way. Methods to calculate the Expectation Index (EI) can be implemented programmatically.

In one embodiment, Expectation Index (EI) calculation is not fully automatable; and the system provides a user interface that guides a worker on how to perform evaluation objectively. To achieve objectivity the evaluation user interface is configured to be restrictive on input the worker is allowed to provide. The input provided by the worker is used to calculate the Expectation Index (EI) based on a published standard or documentation.

In one embodiment, the restrictive user interface (UI) configured to receive input for the evaluation of Expectation Index (EI) is implemented through a highlighter where a worker is allowed to amend a portion of the job output and select the category of quality issue in the amended portion. Categories selectable by the worker from pull-down menus to identify quality issues are configured to have an order such that if a part of job output is evaluated and can be ambiguously categorized, it can be default to the first occurring category it can be classified into. Expectation Index (EI) calculation may include multiple sub-calculations; and to speed up calculation independent sub-calculations can be processed concurrently.

One embodiment of the disclosure includes methods for assigning job properties. For example, the customer submitting a job can tag the job with property tags. For example, an Artificial Intelligent (Al) program can be used to analyze a job and tag the job with property tags in an automated way. For example, workers viewing a job may tag jobs with property tags.

One embodiment of the disclosure includes methods for determining the order to present a job to workers. For example, jobs submitted into the system can be presented to workers using a JIT-BIT scheme. The JIT part of JIT-BIT scheme advocates presenting jobs to qualified workers who are immediately available. The BIT part of JIT-BIT scheme advocates presenting jobs to the best worker who can fulfill the job by matching job properties and current job Expectation Index (EI) (initially 0) with worker properties.

One embodiment of the disclosure includes methods for determining BIT workers to whom a job is to be presented and the order of the BIT workers to whom the job is to be presented. For example, the system considers the compatibility between the job properties and the worker properties to identify BIT workers and to determine the order of the BIT workers for the job. For example, the system is configured to match skill-set requirements and skill-level requirements as closely as possible. For example, the system is configured to consider worker timeliness for that skill-set to ensure requirements on turnaround time can be met. For example, the system is configured to consider worker compensation to ensure the limit on transaction cost is not exceeded.

One embodiment of the disclosure includes methods for iteratively processing jobs until terminal conditions are met. For example, a job is processed iteratively between a work phase and an evaluation phase. A worker is assigned to work on the job during the work phase; and a different worker is then assigned to evaluate the output of the worker who worked on the job during the work phase. In each of the work phase and the evaluation phase, a JIT-BIT scheme is applied to determine the candidates to whom the job will be presented to be worked on or evaluated and the order of the candidates for the presentation. The job is processed iteratively through the work-evaluation cycle until a terminal condition is met. Examples of terminal conditions are Expectation Index (EI) of the job is above a threshold, a limit on turnaround time is reached, a limit on transaction cost is reached, and the customer or a system operator manually intervened to stop the iteration.

In one embodiment, if the job exits the iteration due to Expectation Index (EI) reaching a threshold (e.g., 1), the last worker performing the evaluation is considered as the worker who approves the job output for release to customer.

One embodiment of the disclosure includes methods for handling failure to raise Expectation Index (EI) to a predetermined threshold (e.g., 1). For example, if the system failed to raise the Expectation Index (EI) of a job to the predetermined threshold before another terminal condition is satisfied, the system may attempts to ‘rectify’ the failed expectation by granting the customer an option to accept the job output for a pre-determined fraction of transaction cost or an option to request for a full-refund.

One embodiment of the disclosure includes methods for assigning worker properties. For example, workers may voluntarily provide inputs to specify their skill-set, skill-level, and compensation rate as profiles of the workers. Each skill-set, skill-level pair has implicit quality and timeliness metrics associated with the pair. Default values (e.g., null) are used if the worker does not provide the input. For example, a worker ratings attribution system updates quality metrics and timeliness metrics of a worker skill-set associated with the job the worker was involved in.

One embodiment of the disclosure includes methods to attribute positive ratings to a worker. For example, the quality and timeliness of each job worked/re-worked on by a worker contributes to the rating of his/her skill-set that is related to the job. Positive rating attribution is carried out after the customer has approved the job output. Positive rating attribution is awarded to all those involved in a customer-approved job depending on the amount of work performed, and the number of iterations his/her work has undergone. When Expectation Index (EI) cannot be measured automatically, the last worker who evaluated the job output as fulfilling Expectation Index (EI) will receive positive rating attributes equivalent to the highest positive attribute rating assigned to the worker within the entire pool of qualified workers.

One embodiment of the disclosure includes methods to attribute negative ratings to workers. For example, when a job output is disputed by a customer, a trusted worker is compensated to investigate the job history and determine how negative rating attribution should be apportioned to those involved in the job of the customer. In one embodiment, the judgment of the trusted worker on apportion is final.

One embodiment of the disclosure includes methods to collect job payment, where customer pays before collecting job output.

One embodiment of the disclosure includes methods to visualize job states and alerts. For example, the current state of a job can be obtained for visualization via a user interface, an application programming interface (API), and/or a push notification mechanism, such as email.

Examples of job states include job submitted, work phase started, work phase ended, evaluation phase started, evaluation phase ended, and iteration number.

Examples of alerts include job states discussed above and other conditions, such as job not picked up after a predetermined time period (e.g., X seconds), job not picked up after a predetermined time of views (e.g., X views), job abandoned after pick up, job having poor Expectation Index (EI) after a predetermined number of work-evaluation iterations (e.g., X iterations), job having poor Expectation Index (EI) when reaching a predetermined time threshold before the requested turnaround time (e.g., X seconds before expected turnaround time). In one number, the conditions for triggering the alerts are customizable. For example, the number X in the examples discussed above can be customized for requesting customized alerts for a specific job.

In one embodiment, filters on job properties can be applied to customize the presentation of jobs displayed via the user interface (UI), query results returned via the application programming interface (API), or notifications sent by push mechanisms. Push notification can be turned on or off.

One embodiment of the disclosure includes methods for providing feedback on the completion of work. For example, once a job has exited the system, each worker who has worked and/or evaluated the job is allowed to see his/her worker rating attribution and the job rectifications. However, workers are not provided with access to the identities of workers who did rectification.

One embodiment of the disclosure includes methods for flagging issues. For example, where workers can flag any rectification in job re-work that is visible to them. When the number of flags on a rectification or on a worker exceeds a threshold, a trusted worker in the corresponding job type will be enlisted to review the worker or rectification to assign appropriate negative ratings to the worker.

One embodiment of the disclosure includes methods for detecting manipulation. For example, data for the top X workers, in terms of payout, completed jobs is cross-referenced Y days, where X and Y are integers. Data for pools of workers in jobs will be analyzed for patterns using publicly available algorithms.

One embodiment of the disclosure include methods for preventing job holding as each worker is allowed to only undertake a single job at a time.

In one embodiment, in JIT part, jobs are still shown to BIT workers, but they cannot pick the jobs up (until they become available to work on the jobs).

In one embodiment, the two-phase work-evaluation process becomes a three-phase process that includes a work phase, an evaluation phase, and a rectification phase.

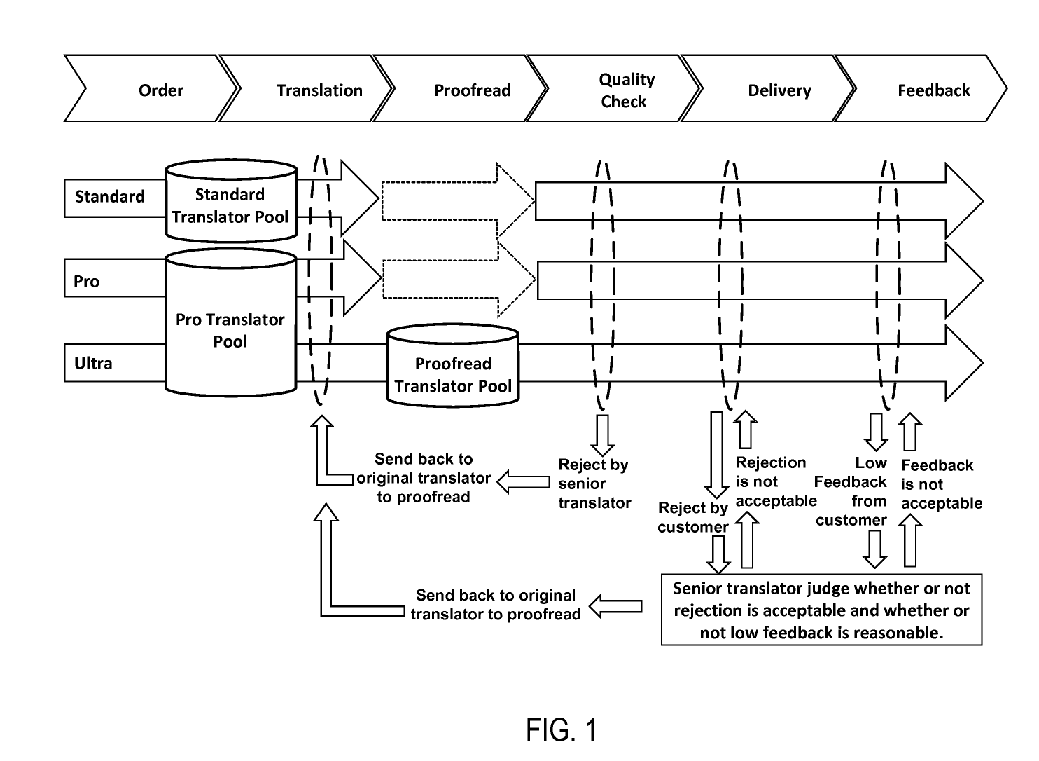

FIG. 1 illustrates a system configured to manage workers according to one embodiment.

In FIG. 1, the processing of a translation job submitted by a customer involves processing stages such as order, translation, proofread, quality check, delivery and feedback.

In FIG. 1, workers are organized in a hierarchy according to their skill level. The work output of a worker is reviewed by a senior worker in the hierarchy during the quality check.

### Hierarchical Structure

In one embodiment, the system operates by the work of a hierarchical system of lay workers (e.g., standard workers in FIG. 1), professional workers (e.g., pro workers in FIG. 1), and trusted experts (e.g., ultra workers in FIG. 1). Higher-tiered workers manage lower-tiered workers and make data-based decisions about improving quality and efficiency.

### Job Classification

In one embodiment, jobs are classified by various criteria, including type and difficulty. Once the order of a job is placed, the job is made available to a pool of pre-tested workers to work on.

If a job is classified as unacceptable, the system allows workers to flag the job for the review by a trusted expert.

### Communication

In one embodiment, the system is configured to allow customers and workers to have open and monitored communication. The privacy of customers and workers is protected with a unique identification number assigned to both. By disabling the ability to view email addresses, communications between customers and workers remain on the system.

Prior to a worker committing to a job, the worker is provided with access to preview the job, including notes and instructions given by the customer, and to view the system-determined deadline.

Once a job completed, the system provides the customer with access to preview the completed job without access to copy or receive it until the customer has approved the completed job. During the preview, the system allows the customer to ask for clarification, request amendments and corrections, and offer feedback and ratings.

Workers are alerted about jobs available for the workers to work on, through the use of algorithmic instant job notifications, hourly email notifications RSS feeds, or by viewing the system dashboard. The available jobs are identified based on the qualifications of the workers.

### Testing Process

In one embodiment, the system requires that workers undergo a series of screening and testing processes before receiving access to the system. A minimum two-stage testing process is used at the onset of the qualification process: machine graded test for screening unskilled and under-qualified applicants, and human graded test for determining the skill-set and skill-level of qualified applicants.

In one embodiment, test results are based at least in part on the ability of an applicant (e.g., potential worker) to follow the directions outlined prior to the screening and testing process.

In one embodiment, tests and system entry are turned on/off and open/closed depending job pickup times and the number of qualified workers available to complete all available tasks.

### Quality Assurance

In one embodiment, in addition to the initial screening and testing phase, the outputs of workers undergo a series of checks and random assessments, machine and/or human-powered, to ensure output is consistent and of high quality. Workers showing signs of underperformance may receive warnings, demotions, or removal from the system. A worker who has scored poorly in previous customer assessments is reviewed more frequently than those who consistently perform well. Data regarding each job ordered via the system (ratings, acceptance, rejection/revision rates, and internal quality ratings) is tracked, analyzed, and used for improving overall system performance.

### Collaboration

In one embodiment, the system is configured to offer services at scale through crowd-sourcing. This structure makes it possible to simplify complex and lengthy jobs making them shorter and more manageable, resulting in faster delivery time.

In one embodiment, the system benefits a worker by providing the worker the freedom to choose from jobs the worker is qualified to complete during any given time, which removes the need for administration and allows workers to have access to a constant job flow.

### Ordering Process

In one embodiment, the system provides customers with a number of different tools when the ordering.

For example, once a customer orders a job that has not been picked up by a worker after a predetermined time period (e.g., one hour), or after a predetermined number of workers have previewed the job but did not pick up the job, the system notifies the customer to solicit more information from the customer. The notification allows the customer to know in a timely manner whether there is an issue with the job submitted by the customer.

For example, customers are provided with the option to invite the previous worker(s) to complete reoccurring jobs ordered at a later date. Such previous workers are considered preferred workers. The use of preferred workers allows the jobs of the customers to be completed in the most consistent manner. The preferred-worker approach also compensates and motivates the worker to maintain high-quality output, by providing the worker with access to more work.

For example, the system provides customers an interface to submit a glossary of terms when ordering translation jobs. The term glossary ensures the important words and phrases that appear in the text are consistently translated in the desired manner.

For example, the system provides customers with access to cancel a job order, should the customer places an order and then decides to cancel. In one embodiment, the customer can cancel a job for a full refund, before a worker completes the job.

### Tools and Resources

In one embodiment, the system provides workers with a variety of tools and resources.

For example, the system is configured to provide a style guide that stipulates language-specific rules that workers are required to follow unless customers specify otherwise. Rules focus on points of the debate to ensure consistent usage throughout each language.

For example, the system is configured to provide learning resources, including a series of lessons for beginner workers to help them fine-tune their skills and approach.

For example, the system provides translator forums that serve as a platform for workers to seek information. In one embodiment, the translator forms provide a central place for information.

### Quality Control

At least one embodiment of the disclosure provides a system and methods to exploit round-the-clock availability and vast skill-set of the pool of workers while ensuring quality, turnaround time and transaction cost meets job requester expectation.

In one embodiment, methods are configured to accept job requests from customers over the Internet using a server system. However, one skilled in the art would appreciate that the job requests can be accepted via alternative systems such as a 3G cellular communication network, a brick-and-mortar office accepting jobs through snail mail, etc.

During the job submission, a customer is prompted to answer one or more multiple-choice questions. Expectation Metrics (EM) pre-determined for the answers that are selected by the customer are associated with the job as properties. Expectation Metrics (EM) includes job quality metrics, and requirements on turnaround time and transaction cost.

In one embodiment, the multiple-choice questions are simple questions in layman language that are re-worded from complex job-specific quality questions into easier ones. For example, instead of asking a customer who is requesting a programming task whether the usage of design patterns is mandatory or if logging is required, the customer can instead be asked whether the job output is going to be used in a production environment or run as a standalone program. If the answer is the former, the response to both complex job specific quality questions will be yes, otherwise both are no.

The multiple-choice questions serve three purposes: 1) to reduce the number of questions asked, 2) to prevent the customer from having to articulate the complex required job output quality by unambiguously defining the quality requirements on behalf the customer, and 3) to prevent customers from keying in unrealistic expectations that the system needs to reject.

In one embodiment, the multiple-choice questions are designed to be mapped to job quality metrics that are quantifiable. The quantifiable quality metrics enable the system to prove that the quality has been met and reduce dispute. The Expectation Metrics (EM) is presented to the customer for his/her perusal or reference, which is needed when the customer wishes to raise a dispute.

Upon agreeing that the customer has reviewed the Expectation Metrics (EM), the job undergoes a two-phase work-evaluation iteration. The system employs a JIT-BIT scheme to determine to whom and in which order the jobs will be presented for pick-up.

The JIT part of JIT-BIT advocates presenting jobs to workers in order of availability to achieve faster job pick-up. The BIT part of JIT-BIT advocates presenting jobs to the best worker who can fulfill the job by matching job properties and current job EI with worker properties to achieve maximizing the quality part of Expectation Metrics (EM) without exceeding transaction cost.

In the work phase, the worker who picks up the job works on the job, making it unavailable to others. Each worker is permitted to pick up only one job to prevent job holding, which may negatively impact the turnaround time performance of the job.

Upon completion, the job enters the evaluation phase in which the system calculates the Expectation Index (EI) of the job: a measurement of the ratio of quality Expectation Metrics (EM) that has been met. Expectation Index (EI) evaluation can be automatic or semi-automatic.

A job can be split into different parts or evaluated as a whole by the same/different worker/automated system serially/concurrently, in order to speed up EI evaluation.

For semi-automated evaluation, a worker to evaluate the job is sought by employing the JIT-BIT scheme. The worker evaluates the Expectation Index (EI) of the job is provided with a user interface for assistance. The user interface is designed to guide the worker to perform evaluation objectively; and the user interface is designed to restrict worker input during evaluation. The restrictive user interface for evaluation has a highlighter and pull-down options. A worker can use the highlighter to highlight part of the job output that has poor quality and select from the pull-down a quality category that best describes the issue. In the case of multiple possible categorizations, the topmost category is always chosen.

The restrictiveness of the user interface for evaluation is designed to: (1) standardize categorization of quality issues to ensure evaluation consistency, (2) require the worker to only perform the simple task of highlight-and-categorize to reduce overly-subjective thinking process and to make the evaluation more objective, and (3) concentrates the worker attention on a small part of the job output at a single time to alleviate his/her judgment from being clouded or influenced by previous or overall quality issues, which can lead to more lenient judgment as evaluation progresses.

If a terminal condition is met (e.g., Expectation Index (EI) reaches 1, turnaround time is reached, or transaction cost is exceeded), the job exits the iteration. When a negative terminal condition is met (e.g., turnaround time is reach, or transaction cost is exceeded, but the Expectation Index (EI) is not close to 1), a catch-all fulfillment process is triggered, which allows the customer to accept the job output at a reduced cost or request a full refund. With a non-deterministic worker pool where the predictability of worker availability is poor, a catch-all fulfillment process is necessary as a last resort.

If terminal conditions are not met, the processing of the job cycles back into the work phase. If Expectation Index (EI) evaluation was semi-automatic, the worker performing the evaluation will proceed to re-work the job. Otherwise, the JIT-BIT scheme will be used to present the job to workers to re-work it. The work-evaluation cycle is repeated until a terminal condition is met.

The iterative process enables the system to utilize the worker pool without over-relying on specific workers of skill-set and skill-level that may be high in demand. The chaining of multiple workers to re-work the same job can increase synergy and ideally raise the job output quality to meet the Expectation Metrics (EM) before turnaround time and transaction cost is exceeded.

The structure of the iterative work-evaluation process, JIT-BIT scheme, and the catch-all fulfillment also simplifies system implementation, since there is no need for complex algorithms to predict worker availability, predict incoming job load/type, reserve worker for jobs, schedule jobs, and resolve contention for workers in high-demand.

The JIT-BIT scheme, allows lower skilled worker to work on jobs, the output of which will potentially be corrected in the next cycle; and the feedback system enables the worker to learn from re-works on their work. The feedback system does not disclose the identity of workers who did the re-working to avoid workers from holding grudges against people who evaluated his/her job output negatively and then re-worked (rectified) it.

When a job exits due to Expectation Metrics (EM) being met (e.g., Expectation Index (EI) is not close to 1 or above a threshold), a customer can dispute the quality of the job output. Disputed cases for jobs with semi-automated Expectation Index (EI) evaluation take precedence in processing. Automated Expectation Index (EI) evaluation is objectively quantifiable and Expectation Metrics (EM) has already been communicated during job submission in a layman language through the multiple-choice question; thus, the job quality controlled via automated Expectation Index (EI) evaluation is almost undisputable.

In one embodiment, positive rating attribution to a worker is performed out automatically and is proportional to how much work/re-work was performed by the worker and inversely proportional to the number of re-work cycles it takes to meet the Expectation Metrics (EM).

For jobs requiring semi-automated Expectation Index (EI) evaluation, the worker whose has a job output being evaluated to meet the Expectation Metrics (EM) of the job will receive positive rating attributes equivalent to the highest positive attribute rating assigned to workers within the entire pool of workers.

For jobs that exit according to negative terminal conditions, a domain expert is enlisted together with a system expert to study the job re-work history and job workflow to determine the cause. If the cause is not system related, the domain expert will determine how negative ratings are attributed to the works involved in the jobs.

The attribution system is designed to encourage workers to perform work-evaluation phase accurately to get jobs out of system quickly with EI of one. The benefits are workers getting more positive attribution (fewer workers in worker pool) and less risk of jobs exiting according to negative terminal conditions, which results in negative attribution. The attribution system is also designed to discourage cheating to get positive attribution such as (1) making minor modifications earns only a small compensation and can be detected when analyzed by pattern recognition algorithms and (2) making major modifications through merely re-jigging job output makes little sense since evaluating the job as meeting EI earns high positive attribution with less work.

With quantifiable and consistent Expectation Index (EI) evaluation, the system removes the need to preview a job output prior to payment; and the customer is more willing to pay upon job submission.

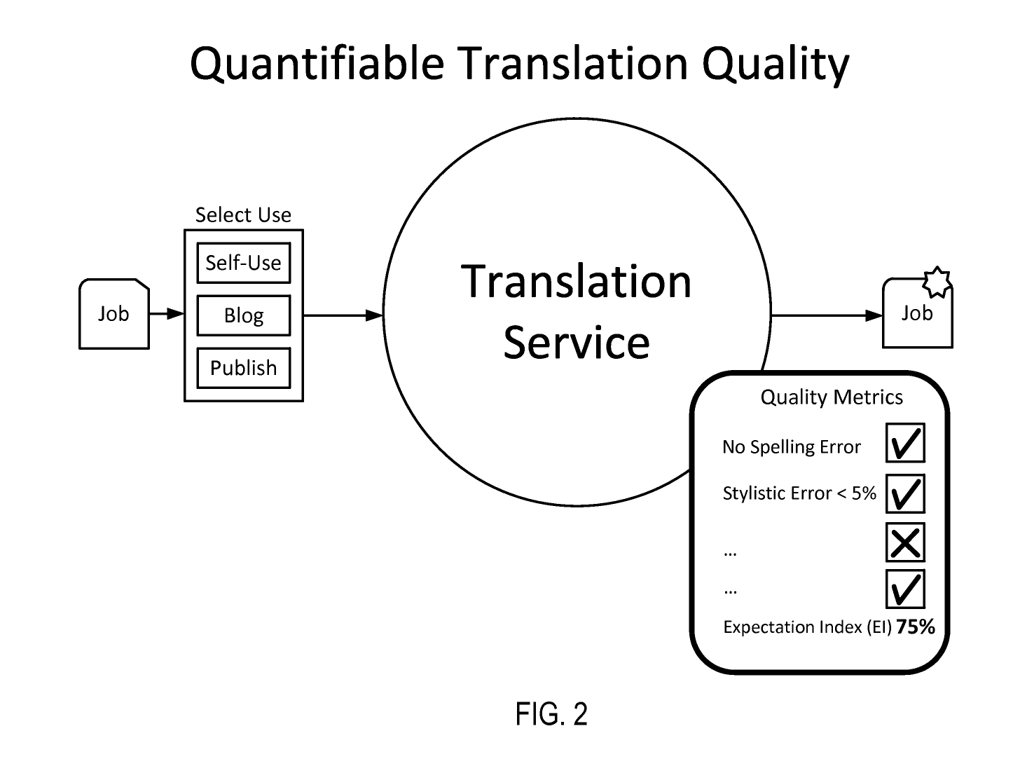

FIG. 2 illustrates a system to control quality for translation jobs according to one embodiment.

In FIG. 2, a job submitted by a customer is configured to receive an answer related to the intended use; and the answer is configured to be selected by the customer from a set of predetermined choices. The answer selected by the customer is pre-associated with job quality metrics, which can be measured during the translation service to determine the Expectation Index (EI) of the job output. The job exits the translation service after a terminal condition is satisfied.

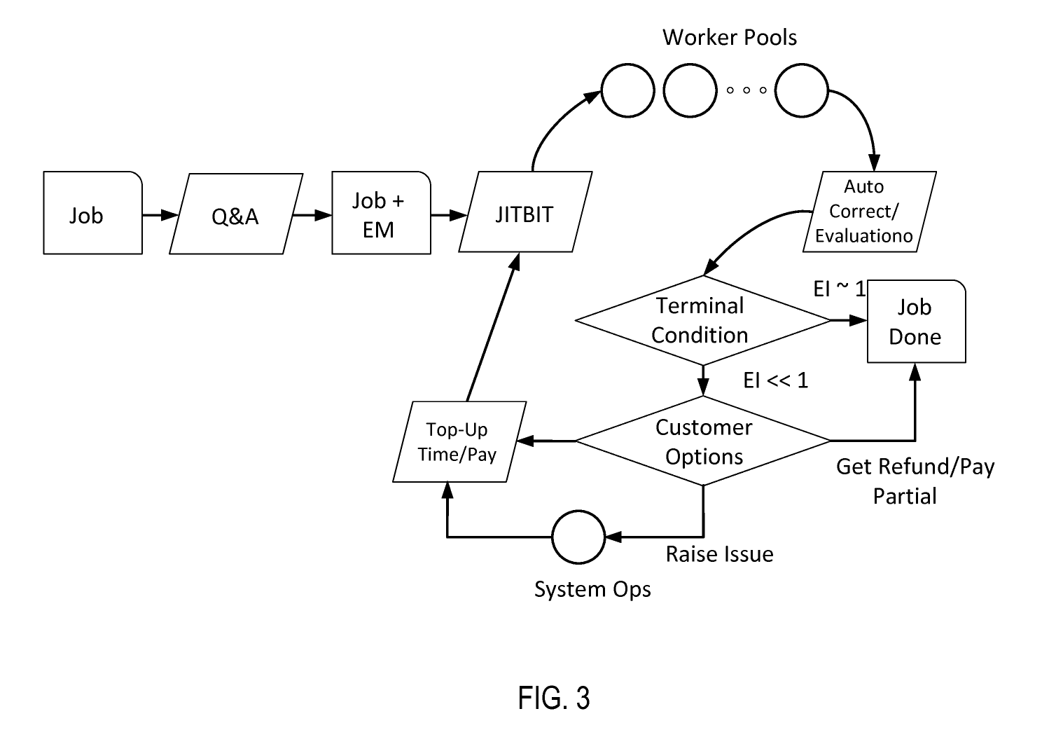

FIG. 3 illustrates a system to control expectation for outsource jobs according to one embodiment.

### Work Progress Control

In one embodiment, techniques in areas of natural language processing and machine learning are combined to improve quality and throughput on a crowdsourcing platform.

In on embodiment, a unit of work to be performed on the crowdsourcing platform includes transformation performed on a text, including but not limited to transcription, translation, or proofreading.

In one embodiment, a component called Zurich hereafter is configured to provide the workers participating in the crowdsourcing platform with automated tools that combine various technologies, such as Natural Language Processing (NLP), Machine Learning (ML) and statistics that the platform accumulates through the process of transformation of the text. Zurich improves the throughput of the platform and quality of the transformation performed by the platform by aiding the workers to improve their speed as well as their output quality, and by automating task assignment and management, such that the tasks can be complete via workers participating in the crowdsourcing platform to carry out the transformation on the text; and the transformation can be carried out via the crowdsourcing platform on a large scale while minimizing the management efforts.

In one embodiment, Zurich provides and relies on data handling: data collection, data processing, and data application. Zurich is configured to: better classify the types and features of the transformation; automate the detection of incomplete or bad transformations; and assign transformations to the “best fit” worker at a given time.

In one embodiment, the crowdsourcing platform usually does not have control over whether or when workers take and actually do work. Workers are not bound by any contract to take specific pieces of work. Workers may choose freely.

### Data Collection

In one embodiment, Zurich uses pre-computed statistical data as well as real-time computed data to compute several metrics and scores, such as:

a complexity score (CS) of the transformation (taking into account the unit count as well as the number of unique words);

working times and throughput of workers;

information on which workers currently working on a transformation;

document similarity (DS) between source and target text based on a vector space model, which is recorded at start and end of the transformation as well as while the transformation is ongoing to determine the rate of change in transformations and the speed of workers;

Vector space model based document similarity (DS) between a new transformation and prior transformations to find workers who did semantically similar transformations in the past;

quality ratings of transformations as rated by customers or staff;

quality ratings of workers as rated by customers or staff;

time zone differences between customers and workers; and

workers who are currently online, logged into the platform, but not active on any transformation and thus free to pick up a task.

In one embodiment, data collection is performed partly through events being triggered from the platform (auto-saving, submission of a unit of work) as well as batch processing and events triggered by certain transaction types directly in the data store.

### Data Processing

In one embodiment, Zurich is configured to use the collected data to generate scores and classifications, which are recalculated in sufficient intervals. For example, a completeness score (CS) for translation transformations can be computed using several techniques, such as Language Detection (LD), Longest Common Substring (LCS), Length Ratio (LR), and/or Document Similarity (DS). The system scores the completeness of a transformation using the techniques.

In one embodiment, to determine whether a translation transformation is complete, or how far or close it is from being incomplete or complete, Zurich combines the aforementioned techniques. Using statistical data generated by analyzing prior translation transformations, Zurich can scores a new translation transformation with respect to the statistical data. Examples of scores include:

a sore based on Language Detection (LD) configured to indicate what language is the given text written in (may include a reliability score for the given prediction), where the score is normalized against the sample data;

a score of the Length Ratio (LR) between the source text and the target text, and a distance of the Length Ratio to the sample data, where the greater the distance the less likely the transformation is done in a correct way;

a score of the Longest Common Substring (LCS) of two pieces of text and the deviation of that length from the statistical mean; and

a score of Document Similarity (DS) evaluated based on the cosine difference of two document vectors representing the source text and the target text to indicate the level of similarity between two documents, where the similarity should be low for a translation to be judged for completeness.

In one embodiment, the statistical data is computed on a per language pair basis. The averages, standard deviation, etc. are calculated for each language pair separately. Texts are also classified into different classes according to their lengths. The averages, standard deviation, and the scores are computed separately for different length classes within the language pairs.

In one embodiment, a threshold can be chosen for each of the above discussed scores for the determination of whether a translation transformation is to be considered incomplete. When a transformation is considered incomplete staff will check the classification. Whether or not the classification was correct will be recorded.

In one embodiment, after collecting a sufficient amount of scores and correctness of the classification, the data can be used to construct a hypothesis function that weights the different scores differently. The weights are calculated using by applying multivariate linear or polynomial regression to the datasets. The weighted sum of the scores is used as a completeness measurement for transformations.

In one embodiment, the coefficients can be either adjusted in a batch process that runs at sufficient intervals, or by implementing a neural network to classify whether a translation is complete or not that uses back propagation to adjust its weights directly in each classification process.

In one embodiment, Zurich is further configured to determine one or more of: Worker Transformation Capacity (WTC), Language Pair Service (LPS) capacity, and Content based Best-Possible-Fit (BPF) Worker Score.

In one embodiment, Worker Transformation Capacity (WTC) profiles or fingerprints the work time habits of a worker per hour and day of a week. The profile includes not only the information on whether or not a worker statistically works on during a particular hour on a particular day in a week (e.g., a Monday at 7:00), but also information on the amount of work that had been done on average during the particular hour on the particular day in the week. In one embodiment, Worker Transformation Capacity (WTC) gives a bias towards recent work activity to gradually phase out workers that had a high throughput prior to a predetermined time period (e.g., 6 months ago) but have not logged into the platform since then.

In one embodiment, the Language Pair Service (LPS) capacity is determined using the capacity scores for each worker.

In one embodiment, Zurich is configured to use Document Similarity (DS), and complexity score (CS) to determine a job preference score indicating whether a worker prefers certain types of content or complexity. The job preference score can be augmented to form a worker profile by adding manual tagging by customers and workers as well as automated Natural Language Processing (NLP) analytics like (e.g., n-gram based) collocation extraction and extraction of hapax legomena (hapaxes).

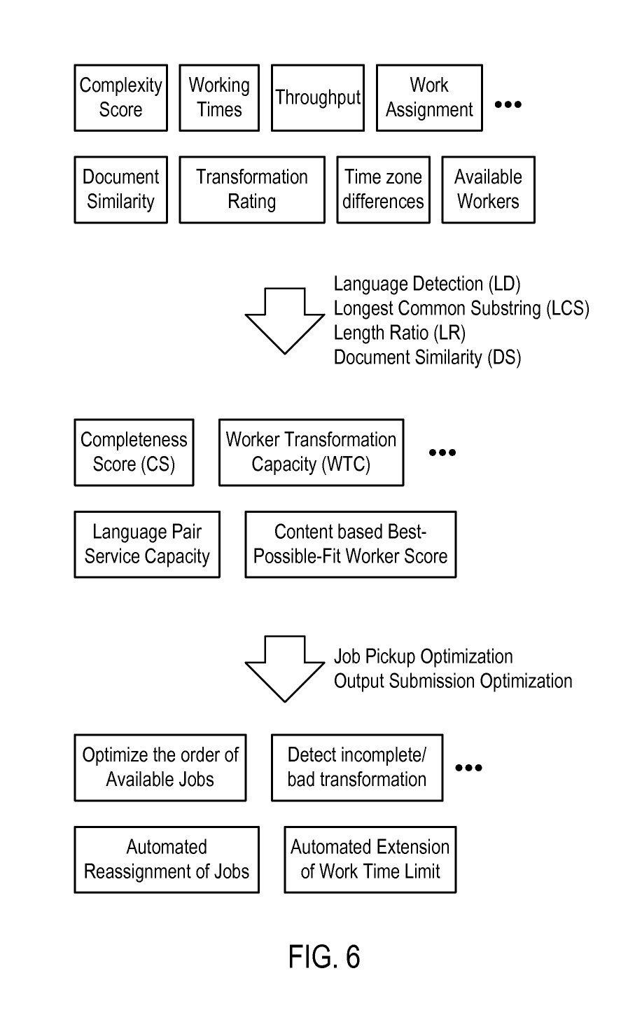

FIG. 6 illustrates a system configured to control work progress of text-based content transformation according to one embodiment.

### Data Application

In one embodiment, the crowdsourcing platform usually has two primary points of interaction with a worker: a pickup interface and a submission interface.

The pickup interface allows a free worker (who currently does not have an assigned work from the crowdsourcing platform) to pick up a unit of work. While the worker has the unit of work, the worker is not considered free to pick up another unit of work until the worker submits the output for the unit of work.

The submission interface allows a worker to submit the output for the unit of work performed by worker.

In one embodiment, the pickup process starts when a unit of work becomes available on the platform and ends when the unit has been picked up by a worker. There are two areas that can be optimized for the pickup process: minimizing the pickup timespan, and increasing the probability of a Best-Possible-Fit (BPF) worker picking up the unit of work.

By ordering the lists of available work units for the workers according to their preference and/or similarity between the available work and prior work performed by the respective workers, the chance of fast pickup as well as BPF pickup should increase. Reassigning work units to specialized workers after regular workers have failed to meet time or quality requirements can also improve the chance of fast pickup as well as BPF pickup.

In one embodiment, the submission process is roughly in the timespan from, e.g., one hour before submission (or timeout by hitting a working time limit imposed by the platform) and the time after submission until approval by the customer.

In one embodiment, Zurich is configured to provide following optimizations of the submission process:

Detecting incomplete/bad transformations before they get submitted and directing the worker towards the problematic parts without staff interaction;

Automatically reassigning transformations that according to CS and WTC score will by no means finish in time; and

Automatically giving the worker the possibility to request an extension of the work time limit if the completeness score suggests that the worker is close to finishing without the need to have staff to manually adjust these limits.

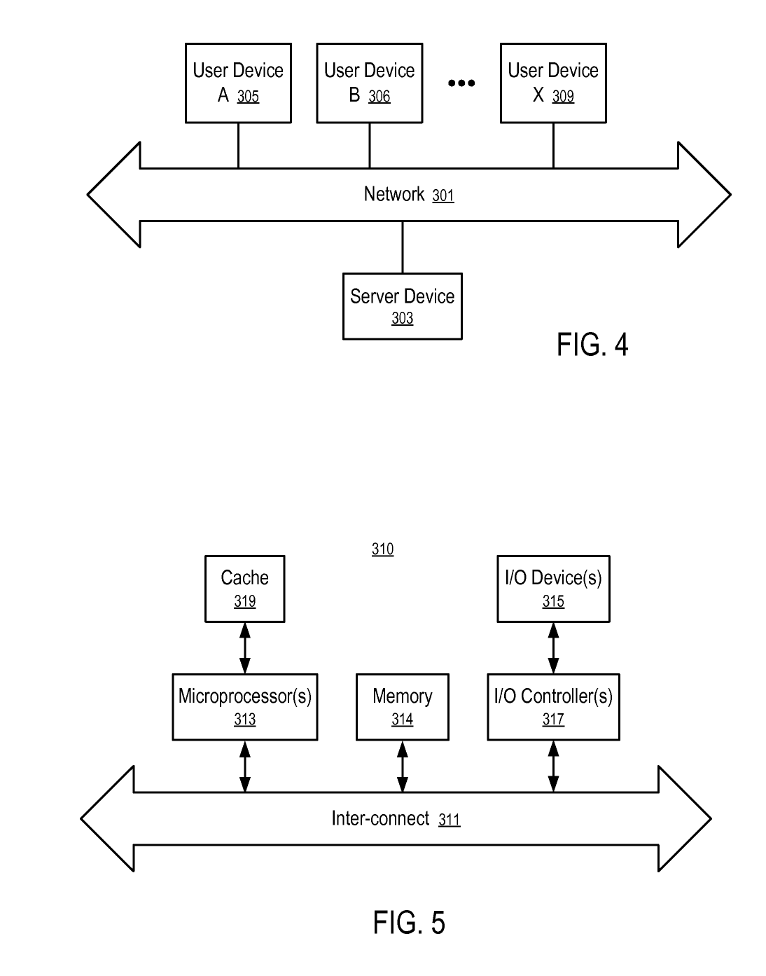

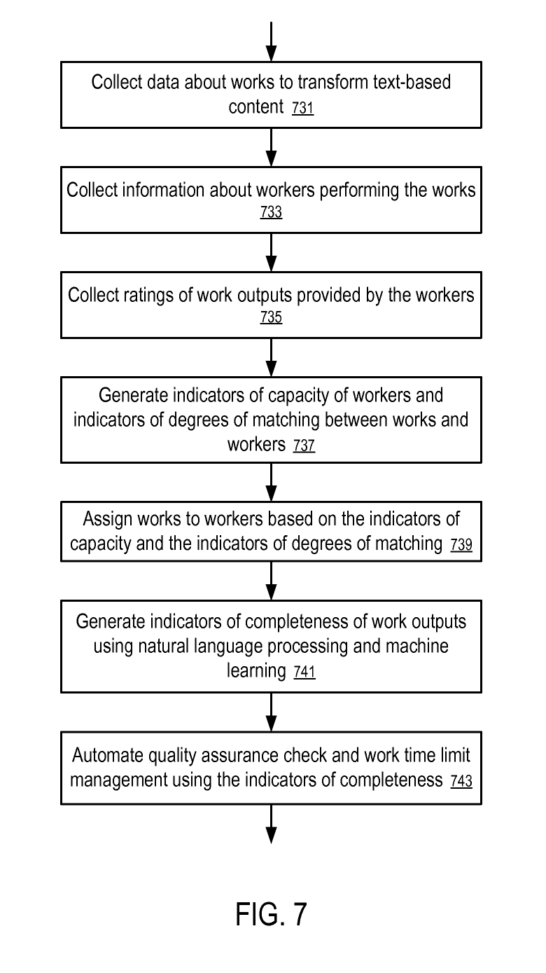

FIG. 7 shows a method to control work progress according to one embodiment. In one embodiment, the method shown in FIG. 7 can be implemented on the translation service platform illustrated in FIG. 2, using data processing systems and devices illustrated in FIGS. 4 and 5.

In FIG. 7, a computing apparatus is configured to: collect (731) data about works to transform text-based content; collect (733) information about workers performing the works; collect (735) ratings of work outputs provided by the workers; generate (737) indicators of capacity of workers and indicators of degrees of matching between works and workers using the collected data, information and ratings; assign (739) works to workers based on the indicators of capacity of workers and the indicators of degrees of matching between works and workers; generate (741) indicators of completeness of work outputs using natural language processing and machine learning; and automate (743) quality assurance check and work time limit management using the indicators of completeness.

### Computing Apparatus

In one embodiment, the operations as illustrated in FIGS. 2 and 3 are configured to be performed on a computing apparatus, such as the server device (303) illustrated in FIG. 4.

FIG. 4 illustrates a system configured to provide services according to one embodiment. In one embodiment, the operations discussed above are implemented at least in part in a service device (303), which can be implemented using one or more data processing systems as illustrated in FIG. 5. A plurality of users devices (e.g., 305, 305, . . . , 309) are coupled to the service device (303) via the network, which includes a local area network, a wireless communications network, a wide area network, an intranet, and/or the Internet, etc.

In one embodiment, the user device (e.g., 305) can be one of various endpoints of the network (301), such as a personal computer, a mobile computing device, a notebook computer, a netbook, a personal media player, a personal digital assistant, a tablet computer, a mobile phone, a smart phone, a cellular phone, etc. The user device (e.g., 305) can be implemented as a data processing system as illustrated in FIG. 5, with more or fewer components.

In one embodiment, at least some of the components of the system disclosed herein can be implemented as a computer system, such as a data processing system illustrated in FIG. 5, with more or fewer components. Some of the components may share hardware or be combined on a computer system. In one embodiment, a network of computers can be used to implement one or more of the components.

In one embodiment, data discussed in the present disclosure can be stored in storage devices of one or more computers accessible to the components discussed herein. The storage devices can be implemented as a data processing system illustrated in FIG. 5, with more or fewer components.

FIG. 5 illustrates a data processing system according to one embodiment. While FIG. 5 illustrates various parts of a computer system, it is not intended to represent any particular architecture or manner of interconnecting the parts. One embodiment may use other systems that have fewer or more components than those shown in FIG. 5.

In FIG. 5, the data processing system (310) includes an inter-connect (311) (e.g., bus and system core logic), which interconnects a microprocessor(s) (313) and memory (314). The microprocessor (313) is coupled to cache memory (319) in the example of FIG. 5.

In one embodiment, the inter-connect (311) interconnects the microprocessor(s) (313) and the memory (314) together and also interconnects them to input/output (I/O) device(s) (315) via I/O controller(s) (317). I/O devices (315) may include a display device and/or peripheral devices, such as mice, keyboards, modems, network interfaces, printers, scanners, video cameras and other devices known in the art. In one embodiment, when the data processing system is a server system, some of the I/O devices (315), such as printers, scanners, mice, and/or keyboards, are optional.

In one embodiment, the inter-connect (311) includes one or more buses connected to one another through various bridges, controllers and/or adapters. In one embodiment the I/O controllers (317) include a USB (Universal Serial Bus) adapter for controlling USB peripherals, and/or an IEEE-1394 bus adapter for controlling IEEE-1394 peripherals.

In one embodiment, the memory (314) includes one or more of: ROM (Read Only Memory), volatile RAM (Random Access Memory), and non-volatile memory, such as hard drive, flash memory, etc.

Volatile RAM is typically implemented as dynamic RAM (DRAM) which requires power continually in order to refresh or maintain the data in the memory. Non-volatile memory is typically a magnetic hard drive, a magnetic optical drive, an optical drive (e.g., a DVD RAM), or other type of memory system which maintains data even after power is removed from the system. The non-volatile memory may also be a random access memory.

The non-volatile memory can be a local device coupled directly to the rest of the components in the data processing system. A non-volatile memory that is remote from the system, such as a network storage device coupled to the data processing system through a network interface such as a modem or Ethernet interface, can also be used.

In this description, some functions and operations are described as being performed by or caused by software code to simplify description. However, such expressions are also used to specify that the functions result from execution of the code/instructions by a processor, such as a microprocessor.

Alternatively, or in combination, the functions and operations as described here can be implemented using special purpose circuitry, with or without software instructions, such as using Application-Specific Integrated Circuit (ASIC) or Field-Programmable Gate Array (FPGA). Embodiments can be implemented using hardwired circuitry without software instructions, or in combination with software instructions. Thus, the techniques are limited neither to any specific combination of hardware circuitry and software, nor to any particular source for the instructions executed by the data processing system.

While one embodiment can be implemented in fully functioning computers and computer systems, various embodiments are capable of being distributed as a computing product in a variety of forms and are capable of being applied regardless of the particular type of machine or computer-readable media used to actually effect the distribution.

At least some aspects disclosed can be embodied, at least in part, in software. That is, the techniques may be carried out in a computer system or other data processing system in response to its processor, such as a microprocessor, executing sequences of instructions contained in a memory, such as ROM, volatile RAM, non-volatile memory, cache or a remote storage device.

Routines executed to implement the embodiments may be implemented as part of an operating system or a specific application, component, program, object, module or sequence of instructions referred to as “computer programs.” The computer programs typically include one or more instructions set at various times in various memory and storage devices in a computer, and that, when read and executed by one or more processors in a computer, cause the computer to perform operations necessary to execute elements involving the various aspects.

A machine readable medium can be used to store software and data which when executed by a data processing system causes the system to perform various methods. The executable software and data may be stored in various places including for example ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a machine readable medium in entirety at a particular instance of time.

Examples of tangible, non-transitory computer-readable media include but are not limited to recordable and non-recordable type media such as volatile and non-volatile memory devices, read only memory (ROM), random access memory (RAM), flash memory devices, floppy and other removable disks, magnetic disk storage media, optical storage media (e.g., Compact Disk Read-Only Memory (CD ROMS), Digital Versatile Disks (DVDs), etc.), among others. The computer-readable media may store the instructions.

The instructions may also be embodied in digital and analog communication links for electrical, optical, acoustical or other forms of propagated signals, such as carrier waves, infrared signals, digital signals, etc. However, propagated signals, such as carrier waves, infrared signals, digital signals, etc. are not tangible machine readable medium and are not configured to store instructions.

In general, a machine readable medium includes any mechanism that provides (i.e., stores and/or transmits) information in a form accessible by a machine (e.g., a computer, network device, personal digital assistant, manufacturing tool, any device with a set of one or more processors, etc.).

In various embodiments, hardwired circuitry may be used in combination with software instructions to implement the techniques. Thus, the techniques are neither limited to any specific combination of hardware circuitry and software nor to any particular source for the instructions executed by the data processing system.

The description and drawings are illustrative and are not to be construed as limiting. The present disclosure is illustrative of inventive features to enable a person skilled in the art to make and use the techniques. Various features, as described herein, should be used in compliance with all current and future rules, laws and regulations related to privacy, security, permission, consent, authorization, and others. Numerous specific details are described to provide a thorough understanding. However, in certain instances, well known or conventional details are not described in order to avoid obscuring the description. References to one or an embodiment in the present disclosure are not necessarily references to the same embodiment; and, such references mean at least one.

The use of headings herein is merely provided for ease of reference, and shall not be interpreted in any way to limit this disclosure or the following claims.

Reference to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, and are not necessarily all referring to separate or alternative embodiments mutually exclusive of other embodiments. Moreover, various features are described which may be exhibited by one embodiment and not by others. Similarly, various requirements are described which may be requirements for one embodiment but not for other embodiments. Unless excluded by explicit description and/or apparent incompatibility, any combination of various features described in this description is also included here. For example, the features described above in connection with “in one embodiment” or “in some embodiments” can be all optionally included in one implementation, except where the dependency of certain features on other features, as apparent from the description, may limit the options of excluding selected features from the implementation, and incompatibility of certain features with other features, as apparent from the description, may limit the options of including selected features together in the implementation.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. A computer-implemented method, comprising:
collecting, in a computing apparatus, data about works to transform text-based content, information about workers performing the works, and ratings of work outputs provided by the workers;
generating, by the computing apparatus using the data, the information and the ratings and using natural language processing techniques and machine learning techniques, indicators of
completeness of work outputs corresponding to works, capacity of workers, and
degrees of matching between works and workers;
assigning, by the computing apparatus, works to workers based on the indicators; and
automating, by the computing apparatus, quality assurance check and work time limit management using at least some of the indicators.

2. The method of claim 1, wherein the computing apparatus comprises a crowdsourcing platform configured to distribute works to workers over Internet without contract.

3. The method of claim 1, wherein an indicator of the completeness of work outputs is computed based on at least one of:
length ratio between a source text to be transformed and a target text resulting from transforming the source txt;
longest common substring the source text and the target text; and
document similarity (DS) evaluated based on a cosine difference of a document vector representing the source text and a document vector representing the target text.

4. The method of claim 1, wherein an indicator of the completeness of work outputs is computed based on a combination of:
length ratio between a source text to be transformed and a target text resulting from transforming the source txt;
longest common substring the source text and the target text; and
document similarity (DS) evaluated based on a cosine difference of a document vector representing the source text and a document vector representing the target text.

5. The method of claim 4, wherein an indicator of the completeness of work outputs is computed further based on a distance of the length ratio to sample data.

6. The method of claim 4, wherein an indicator of the completeness of work outputs is computed further based on a deviation of the longest common substring length from a statistical mean.

7. The method of claim 1, wherein an indicator of the completeness of work outputs is computed based on a hypothesis function of:
a first completeness score based on length ratio between a source text to be transformed and a target text resulting from transforming the source txt;
a second completeness score based on longest common substring the source text and the target text; and
a third completeness score based on document similarity (DS) evaluated based on a cosine difference of a document vector representing the source text and a document vector representing the target text.

8. The method of claim 7, wherein the hypothesis function applies different weights to the first, second, and third completeness scores.

9. The method of claim 8, wherein the coefficients are adjusted in a batch process.

10. The method of claim 8, wherein the coefficients are adjusted via a neural network.

11. The method of claim 1, wherein an indicator of the degrees of matching between works and workers is based on document similarity between works to be performed and works that have been performed by respective works.

12. The method of claim 11, wherein an indicator of the degrees of matching between works and workers is further based on a complexity score computed based on a unit count and a number of unique words.

13. The method of claim 12, wherein an indicator of the degrees of matching between works and workers is augmented with natural language processing analytics.

14. The method of claim 1, wherein the indicator of the capacity of workers is based on a profile of statistical work output in a hour on a day in a week.

15. The method of claim 14, wherein the statistical work output is biased towards recent work activity.

16. The method of claim 1, further comprising:
presenting at least one multiple-choice question to a customer submitting a work to transform a text;
receiving from the customer an answer to the at least one multiple-choice question;
determining an expected quality metrics for the work based on the answer; and
controlling quality of transforming the text on a crowdsourcing platform based on the expected quality metrics.

17. The method of claim 16, further comprising:
iteratively, on the crowdsourcing platform, between transforming the text and evaluating output of the transforming of the text until the expected quality metrics is satisfied, a cost limit is reached, or a turnaround time is reached.

18. The method of claim 17, further comprising:
presenting a task to transform the text or evaluate a result of transforming the text to works in an order according to a just-in-time and best-in-time scheme.

19. A computing apparatus, comprising:
at least one processor; and
a memory storing instructions configured to instruct the at least one processor to:
collect data about works to transform text-based content, information about workers performing the works, and ratings of work outputs provided by the workers;
generate, using the data, the information and the ratings and using natural language processing techniques and machine learning techniques, indicators of
completeness of work outputs corresponding to works, capacity of workers, and
degrees of matching between works and workers;
assign works to workers based on the indicators; and
automate quality assurance check and work time limit management using at least some of the indicators.

20. A non-transitory computer-storage medium storing instructions configured to instruct a computing apparatus to perform at least:
collecting, in the computing apparatus, data about works to transform text-based content, information about workers performing the works, and ratings of work outputs provided by the workers;
generating, by the computing apparatus using the data, the information and the ratings and using natural language processing techniques and machine learning techniques, indicators of
completeness of work outputs corresponding to works, capacity of workers, and
degrees of matching between works and workers;
assigning, by the computing apparatus, works to workers based on the indicators; and
automating, by the computing apparatus, quality assurance check and work time limit management using at least some of the indicators.
